(19) United States
(12) Patent Application Publication
(10) Pub. No.: US 2024/0333761 A1
(43) Pub. Date: Oct. 3, 2024

(54) AUTOMATED EMAIL ACCOUNT COMPRISE DETECTION AND REMEDIATION

(71) Applicant: Cisco Technology, Inc., San Jose, CA (US)

(72) Inventors: Fahim Abbasi, Auckland (NZ); Abhishek Singh, Morgan Hill, CA (US)

(21) Appl. No.: 18/126,827

(22) Filed: Mar. 27, 2023

(51) Int. Cl. H04L 9/40

(52) U.S. Cl. CPC H04L 63/1483; H04L 63/0236

(57) ABSTRACT

Techniques and architecture are described for detecting a compromised mailbox as an email account compromise (EAC) involved in lateral phishing, lateral scam, lateral BEC, outbound scam, lateral and inbound fraudulent money transfer requests. For example, the techniques and architecture provide a method that comprises scanning, by a pre-filter, electronic mail messages (emails) within an organization, wherein the emails originate within the organization. The pre-filter analyzes the emails with respect to known fraudulent email practices and determines that an email is a questionable email. A retrospective behavior engine analyzes the questionable email with respect to one or more historical traits to provide a feature set. Based at least in part on the feature set, the verdict correlation engine determines that the questionable email belongs in a class of emails from multiple classes of emails. Based at least in part on the class, the verdict correlation engine performs a responsive action.

### TECHNICAL FIELD

The present disclosure relates generally to detecting a compromised mailbox as an email account compromise (EAC), and more particularly, to detecting a compromised mailbox as an email account compromise (EAC) involved in lateral phishing, lateral scam, lateral BEC, outbound scam, lateral and inbound fraudulent money transfer requests by analyzing the current email-sending behavior of the sender and comparing it with their retrospective email-sending behavior along with some additional peripheral features from the email.

### BACKGROUND

Email is a vector for a variety of attacks that can open the door for theft, fraud, ransomware, and more. With business email compromise (BEC), one or more techniques are used to convince an email recipient that a message is coming from a legitimate, trusted source when, in fact, it's coming from an entirely nefarious account. The now-trusted message could request the recipient do any number of things, none of which are good for an enterprise. Email account compromise (EAC) is a highly sophisticated email attack leading to financial fraud and information loss. In EAC, malicious threat actors gain unauthorized access to legitimate business email accounts of corporate users to become the targeted user. It provides the perfect impersonation and vantage point to the threat actors, as the email is originating internally from an authenticated corporate account belonging to a legitimate staff member of the organization, thus exploiting the inherent trust that employees have with their colleagues. Thus, whereas a BEC is based on messages that appear to come from a trusted source, in an EAC the messages actually do come from a trusted source. In particular, when compared with BEC scams, it is observed that in BEC scams, the threat actors impersonate an executive or an employee while in EAC scams, the attacker digitally becomes the executive or employee, thus exploiting the inherent trust amongst co-workers. Attackers use various tactics, such as password spray, phishing, scam, BEC, malware, etc., to compromise victims' email accounts, gaining access to legitimate mailboxes.

Cybercriminals gain access to corporate user mailbox credentials using various means such as, for example, obtaining compromised credentials from online dumps, purchasing compromised credentials from dark web marketplaces, targeting corporate users with operating system software suite (e.g., Microsoft® 365) credential phishing, attempting password cracking on corporate user business operating system software suite accounts, targeting corporate users with malware to steal their credentials, etc. Threat actors leverage these compromised corporate accounts to further send email lures like phishing, scam, BEC, malware, etc., both internally within an organization and externally to partners of the organization and other targets to further extend their sphere of influence. In most cases, the threat actors' goal is to trick internal or third-party finance staff into diverting funds to accounts controlled by the threat actors. Since the emails originate internally from legitimate corporate O365 email accounts, the emails easily evade defenses and pass through existing email filters focused on email features on the north-south traffic or inbound/external interface including email authentication controls such as sender policy framework (SPF), domainkeys identified mail (DKIM) and domain-based message authentication, reporting and conformance (DMARC), thus making the emails very difficult to detect.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIGS. 1A and 1B schematically illustrate an example arrangements for detecting a compromised mailbox as an email account compromise (EAC) involved in lateral phishing, lateral scam, lateral BEC, outbound scam, lateral and inbound fraudulent money transfer requests by analyzing the current email-sending behavior of the sender and comparing it with their retrospective email-sending behavior along with some additional peripheral features from the email, in accordance with techniques and architecture described herein.

FIG. 2 schematically illustrates an example flow for the example arrangements of FIGS. 1A and 1B, in accordance with techniques and architecture described herein.

FIG. 3 illustrates a flow diagram of an example method for detecting a compromised mailbox as an email account compromise (EAC) involved in lateral phishing, lateral scam, lateral BEC, outbound scam, lateral and inbound fraudulent money transfer requests, in accordance with the techniques and architecture described herein.

FIG. 4 is a computer architecture diagram showing an example computer hardware architecture for implementing a device that can be utilized to implement aspects of the various technologies presented herein.

### DESCRIPTION OF EXAMPLE EMBODIMENTS

### Overview

The present disclosure provides techniques and architecture for detecting a compromised mailbox as an email account compromise (EAC). More particularly, the techniques and architecture provide for detecting a compromised mailbox as an email account compromise (EAC) involved in lateral phishing, lateral scam, lateral BEC, outbound scam, lateral and inbound fraudulent money transfer requests by analyzing the current email-sending behavior of the sender and comparing it with their retrospective email-sending behavior along with some additional peripheral features from the email.

For example, in configurations, the techniques and architecture provide a design that comprises three components including an adaptive pre-filter, a retrospective behavior engine, and a verdict correlation engine. The pre-filter may use fuzzy logic to detect suspicious traits of emails including, for example, phishing, scam, BEC, malware. The retrospective behavior engine may then analyze the current email-sending behavior of the supposed sender of suspicious emails and compare the such behavior with retrospective email-sending behavior of the purported sender (e.g., the historical behavior of the owner or user of the email account from which the suspicious emails originated) along with some additional peripheral features from the suspicious emails. The verdict correlation engine, upon analysis of suspicious emails and a feature set provided by the retrospective behavior engine, provides a verdict with respect to a class malicious, benign, suspicious email account.

As an example, a method may include scanning, by a pre-filter, electronic mail messages (emails) within an organization, wherein the emails originate within the organization. The pre-filter may analyze the emails with respect to known fraudulent email practices and determines that an email is a questionable email. A retrospective behavior engine may analyze the questionable email with respect to one or more historical traits to provide a feature set and provides the feature set to a verdict correlation engine. Based at least in part on the feature set, the verdict correlation engine may determine that the questionable email belongs in a class of emails from multiple classes of emails. Based at least in part on the class, the verdict correlation engine may perform a responsive action.

### Example Embodiments

In accordance with configurations described herein, as previously noted, the present disclosure provides techniques and architecture for detecting a compromised mailbox as an email account compromise (EAC). More particularly, the techniques and architecture provide for detecting a compromised mailbox as an email account compromise (EAC) involved in lateral phishing, lateral scam, lateral BEC, outbound scam, lateral and inbound fraudulent money transfer request by analyzing the current email-sending behavior of the sender and comparing it with their retrospective email-sending behavior along with some additional peripheral features from the email.

For example, in configurations, the techniques and architecture provide a design that comprises three components including an adaptive pre-filter, a retrospective behavior engine, and a verdict correlation engine. The pre-filter may use fuzzy logic to detect suspicious traits of emails including, for example, phishing, scam, BEC, malware. The retrospective behavior engine may then analyze the current email-sending behavior of the supposed sender of suspicious emails and compare the behavior with retrospective email-sending behavior of the purported sender (e.g., the historical behavior of the owner or user of the email account from which the suspicious emails originated) along with some additional peripheral features from the suspicious emails. The verdict correlation engine, upon analysis of suspicious emails and a feature set provided by the retrospective behavior engine, provides a verdict with respect to a class for the suspicious email that includes malicious, benign, and suspicious.

In configurations, the pre-filter scans internal and outbound emails sent by any user within the organization. These emails are matched against known phishing and scam traits to identify suspicious or questionable emails and are shortlisted for additional analysis.

For all suspicious or questionable (referred to herein as suspicious) emails found, the retrospective behavior engine analyzes uniform resource locators (URLs) in the suspicious emails for anomalies in security certificates such as, for example, secure sockets layer (SSL) certificates, etc., whether the URL belongs to a cloud service or contains URL or base64 encoded components of a URL such as an email within the suspicious email. Internet protocol (IP) addresses of these suspicious emails are analyzed, noted, and later used to compare with historical IP addresses. The retrospective behavior engine checks whether IP belongs to any known block list or suspicious country. Recipients of the suspicious emails are analyzed and compared with historical recipients. The number of recipients is noted.

In configurations, a 90-day (for example) retrospective lookup of the suspicious sender's (originator of the suspicious email) email-sending behavior is performed. The IP address, country, and sub-division of the suspicious sender's IP address are derived and compared with all the suspicious historical IP addresses. A similarity score may be assigned, yielding the most similar match. Clusters are formed on historical IP addresses, their country, and autonomous system number (ASN), and an anomaly detection algorithm is used to compare the detected IP address against these clusters. If there is no match, it is considered an anomaly. The suspicious sender's historical IP addresses are analyzed, looking for patterns that suggest that the suspicious sender's IP address is changing too fast and from far away distances.

The suspicious sender's historical recipients are analyzed and compared with current recipients to derive matching and non-matching relationships. Some additional statistical features are extracted such as, for example, total number of emails sent today, total number of emails sent in the past, average number of emails sent in the past, email ratio, unique historical IP addresses seen in the past, etc.

All this information is then sent to the verdict correlation engine. The verdict correlation engine applies 30 (for example) different rule criteria using different permutations to infer a final verdict for a message and originating mailbox. In configurations, there may be three main categories including benign, suspicious and malicious.

In configurations, the adaptive pre-filter is a system that looks at phishing and scam exemplar emails as input and automatically generates and suggests rules based on high-frequency keywords and key phrases. These high-frequency keywords and keyphrases are extracted using NLP techniques such as N-grams and leverage embeddings from BERT-like models. These keywords and keyphrases are then used to create and suggest rules to the analyst.

In configurations, rules suggested by the adaptive pre-filter to a rule engine are then converted into email detection rules. These rules may be implemented as Yara rules or Rspamd rules and published and deployed in production to scan internal (east-west) and outbound emails. Any matching email is then shortlisted for further analysis by the retrospective behavior engine. Any message matching the adaptive pre-filter criteria is then sent to retrospective behavior engine for additional checks. This engine performs a 90-day retrospective lookup of user email sending meta-data and identifies anomalous behavior patterns in it by comparing it with the current-day email-sending patterns

In configurations, the retrospective behavior engine includes an IP address analyzer. The IP address analyzer obtains the suspicious sender's IP address and derives its country, sub-division, and ASN and provide to second stage detection algorithm. The IP address analyzer then checks the IP address against existing blocklists and reports the results. The IP address analyzer also checks to see if the sender's IP address of subsequent emails being sent are changing too fast and too soon within a window, e.g., the last 2 to 3 weeks. In configurations, the IP address analyzer performs anomaly detection by building clusters of historical unique IP addresses, country code and ASN and comparing detected emails IP addresses, country and ASN with these clusters. If they do not match, the suspicious email may be considered an anomaly. Standard unsupervised learning clustering algorithms are uses such as, for example, a Gaussian mixture model (GMM), to determine the clusters. In configurations, an IP address graph may be created based on the analysis and results of the IP address analyzer.

In configurations, the retrospective behavior engine includes a URL analyzer. The URL analyzer looks for anomalies in security certificate information and checks for base64 encoded components of a URL and URL encoded components of a URL in the suspicious email. The URL analyzer checks whether the URL belongs to a legit cloud service or if the URL is using any anti-evasion feature to deliver URLs such as google redirected.

In configurations, the retrospective behavior engine includes a recipient/relationship analyzer. The recipient/relationship analyzer identifies and reports the unique number of recipients from the suspicious email. Later, the unique number of recipients may be passed on to the second-stage algorithm. The recipient/relationship analyzer collects all recipients from suspicious emails detected by the pre-filter and compares them with all the recipients in the past 90 days, for example. Here, metrics may be derived such as, for example, relationship_found, number of recipient matches using the Jaccard index, number of recipient mismatches, number of unique historical recipients, etc. In configurations, a recipient/relationship graph may be created based on the analysis and results of the recipient/relationship analyzer.

In configurations, the retrospective behavior engine may include an email statistical analyzer that extracts some additional statistical features from the suspicious email sender such as, for example, a total number of emails sent today, a total number of emails sent in the past, an average number of emails sent in the past, an email ratio, and a number of unique historical IP addresses seen in the past. In configurations, an email profiler may be created based on the analysis and results of the email statistical analyzer.

In configurations, the retrospective behavior engine provides the various features to a verdict correlation engine that correlates all of the features. The verdict correlation engine may use human expert knowledge and machine learning to determine the final verdict about a suspicious email and the originating mailbox (suspicious sender's email address from which the suspicious email originated). This final verdict may be one of three classes: benign, suspicious, or malicious.

In configurations, human expert knowledge uses statistical analysis to develop correlation rules on all the features to infer whether the originating mailbox is malicious, suspicious, or benign. Running the system in production with these rules will help catch malicious and benign samples. These samples will later be used by a machine learning model to train on.

The features may be used to train a machine learning model. For this implementation, since a classification problem is being solved, a decision tree implementation may be used. The model is trained on thousands of benign and malicious samples and tested on a test set. If the efficacy is high, this model is pushed into production to help infuse the final verdict. The expert system and the machine learning model work in parallel to give a verdict. Confidence scores may be assigned to the verdict based on agreement or disagreement between these two systems. A high confidence verdict may be the one where both the human expert system and machine learning system have agreed upon the verdict class. A medium confidence verdict may be whenever there is a disagreement.

In configurations, business operating system software (e.g., Microsoft 365) audit logs may be used to determine if there is an account compromise. The audit logs may be used to compare the suspicious email box (originator) recent activities with historical activities of the suspicious email box. Additionally, VPN logs may be used to determine if there is an account compromise. The audit logs may be used to compare the suspicious email box (originator) recent activities with historical activities of the suspicious email box.

Once a malicious mailbox is identified, all malicious emails sent by this user are pulled out of all recipient mailboxes within the organization using a retrospective API. A compromised email address is sent to a security platform, which can be used send to an active directory (AD) and/or cloud access security broker (CASB) to suspend the email address and/or enforce policy to suspend the email address.

In configurations, if the output of the verdict correlation engine is benign, then the email mailbox/address/account from which the suspicious email originated may be labelled as safe. In configurations, if the output of the verdict correlation engine is suspicious, the suspicious email address, along with the feature set extracted from the email, is sent to a security software platform. The security software platform pulls email rules created for the user account (the suspicious email box that originated the suspicious email) from an email exchange. For a compromised account, threat actors usually enforce the email rules to forward any invoice or money transfer request to the free email addresses or non-corporate email addresses, delete the emails from the mailbox, forward the email to the trash, etc. The security software platform also pulls out the historic VPN logs of the user. VPN logs contain historic records about the device information from where a user generally logs on, login failure attempts, etc.

In configurations, an alert correlation engine at the security software platform correlates the feature set of suspicious email addresses from the verdict correlation engine, correlates with the rules from the email exchange and historical VPN logs to render a verdict on account compromise. Correlation is done by combining the feature set as rules and giving a verdict as a compromised email account or using a supervised learning algorithm to give the verdict as a compromised account.

Once it has been determined that the account has been compromised, e.g., is malicious, the security software sends an actual address to the active directory (AD) and cloud access security broker (CASB). The CASB can enforce policy to block the email address, and the active directory suspends the email account.

Accordingly, in configurations, a method includes scanning, by a pre-filter, electronic mail messages (emails) within an organization, wherein the emails originate within the organization. The pre-filter analyzes the emails with respect to known fraudulent email practices and determines that an email is a questionable email. A retrospective behavior engine analyzes the questionable email with respect to one or more historical traits to provide a feature set. The retrospective behavior engine provides the feature set to a verdict correlation engine. Based at least in part on the feature set, the verdict correlation engine determines that the questionable email belongs in a class of emails from multiple classes of emails. Based at least in part on the class, the verdict correlation engine performs a responsive action.

In configurations, the multiple classes comprise benign, suspicious, or malicious. In some configurations, if the questionable email is benign, the responsive action comprises deeming an originating email address of the questionable email as safe.

In configurations, if the questionable email is deemed malicious, the responsive action comprises forwarding an originating email address of the questionable email to a security platform that forwards the originating email address to an account directory that suspends an account of the originating email address and a cloud access security broker that blocks the originating email address. In such configurations, the responsive action further comprises removing the questionable email from any email accounts that received the questionable email.

In configurations, analyzing the mail with respect to the one or more historical traits to provide the feature set comprises one or more of analyzing uniform resource locators (URLs) in the questionable email for one or more of anomalies in security certificates, whether a URL belongs to a cloud service, or whether the URL contains URL or base64 encoded components of a URL; analyzing internet protocol (IP) addresses in the questionable email and one or more of comparing the IP addresses with historical IP addresses, checking whether an IP address is included on a list of blocked IP addresses, or checking whether the IP address is located in a suspicious country; comparing one or more recipients with historical recipients; or analyzing a historical email sending behavior of a sender of the questionable email.

In configurations, analyzing the questionable email with respect to one or more historical traits to provide the feature set comprises one or more of analyzing operating system audit log events or analyzing virtual private network (VPN) logs

Thus, the techniques and architecture described herein help an organization detect compromised email mailboxes as email account compromise (EAC), lateral phishing, and lateral scam by analyzing the current email-sending behavior of the sender and comparing it with the sender's retrospective email-sending behavior along with some additional peripheral features from the email. This capability may integrate into a secure email gateway (SEG) and helps users detect internal threats that otherwise would not have been detected due to the nature of the compromise.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

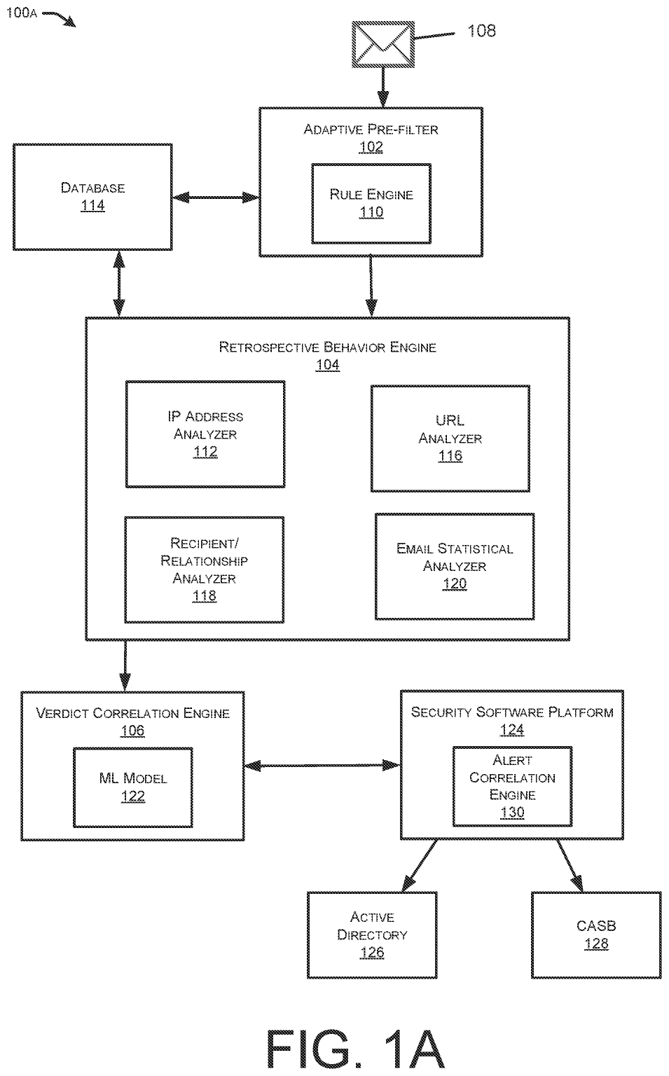

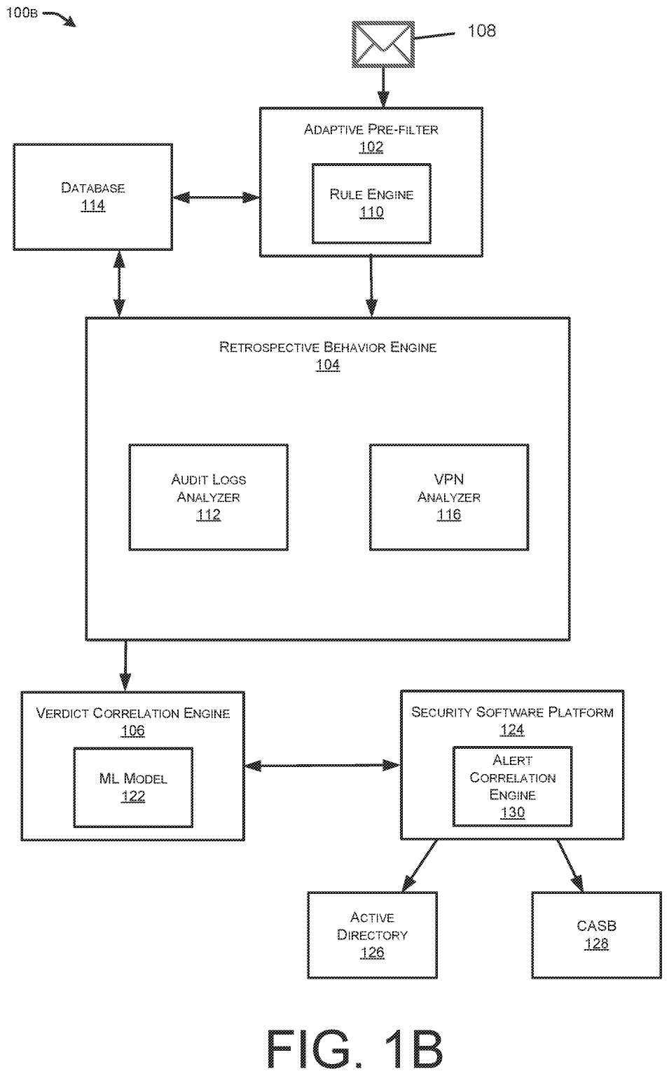

FIG. 1A schematically illustrates an example arrangement 100a that includes an adaptive pre-filter 102, a retrospective behavior engine 104, and a verdict correlation engine 106.

In configurations, the adaptive pre-filter 102 may use fuzzy logic to detect suspicious traits of emails 108 including, for example, phishing, scam, BEC, malware. The retrospective behavior engine 104 may then analyze the current email-sending behavior of the supposed sender of suspicious emails and compare the behavior with retrospective email-sending behavior of the purported sender (e.g., the historical behavior of the owner or user of the email account from which the suspicious emails originated) along with some additional peripheral features from the suspicious emails. The verdict correlation engine 106, upon analysis of suspicious emails and a feature set provided by the retrospective behavior engine 104, provides a verdict with respect to a class that includes malicious, benign, and suspicious.

In configurations, the adaptive pre-filter 102 scans internal and outbound emails 108 sent by any user within an organization. These emails 108 are matched against known phishing and scam traits to identify suspicious or questionable emails and are shortlisted for additional analysis.

For all suspicious or questionable (referred to herein as suspicious) emails found, the retrospective behavior engine 104 analyzes uniform resource locators (URLs) in the suspicious emails for anomalies in security certificates such as, for example, secure socket layer (SSL) certificates, etc., whether the URL belongs to a cloud service or contains URL or base64 encoded components of a URL such as an email within the suspicious email. Internet protocol (IP) addresses of these suspicious emails are analyzed, noted, and later used to compare with historical IP addresses. The retrospective behavior engine 104 checks whether IP address belongs to any known block list or suspicious country. Recipients of the suspicious emails are analyzed and compared with historical recipients. The number of recipients is noted.

In configurations, a 90-day (for example) retrospective lookup of the suspicious sender's (originator of the suspicious email) email-sending behavior is performed by the retrospective behavior engine 104. The IP address, country, and sub-division of the suspicious sender's IP address are derived and compared with all the suspicious historical IP addresses. A similarity score may be assigned, yielding the most similar match. Clusters are formed on historical IP addresses, their country, and autonomous system number (ASN), and an anomaly detection algorithm is used to compare the detected IP address against these clusters. If there is no match, it is considered an anomaly. The suspicious sender's historical IP addresses are analyzed by the retrospective behavior engine 104, looking for patterns that suggest that the suspicious sender's IP address is changing too fast and from far away distances.

The suspicious sender's historical recipients are analyzed by the retrospective behavior engine 104 and compared with current recipients to derive matching and non-matching relationships. Some additional statistical features are extracted such as, for example, total number of emails sent today, total number of emails sent in the past, average number of emails sent in the past, email ratio, unique historical IP addresses seen in the past, etc.

All this information is then sent to the verdict correlation engine 106. The verdict correlation engine 106 applies 30 (for example) different rules criteria using different permutations to infer a final verdict for a message and originating mailbox. In configurations, there may be three main categories including benign, suspicious and malicious.

In configurations, the adaptive pre-filter 102 is a system that looks at phishing and scam exemplar emails as input and automatically generates and suggests rules based on high-frequency keywords and key phrases. These high-frequency keywords and keyphrases are extracted using NLP techniques such as N-grams and leverage embeddings from BERT-like models. These keywords and keyphrases are then used to create and suggest rules to a rule engine 110.

In configurations, rules suggested by the adaptive pre-filter 102 to the rule engine 110 are then converted into email detection rules. These rules may be implemented as Yara rules or Rspamd rules and published and deployed in production to scan internal (east-west) and outbound emails. Any matching email is then shortlisted for further analysis by the retrospective behavior engine. Any message matching the adaptive pre-filter criteria is then sent to retrospective behavior engine for additional checks. The rule engine 110 performs a 90-day (for example) retrospective lookup of user email sending meta-data and identifies anomalous behavior patterns in it by comparing it with the current-day email-sending patterns.

In configurations, the retrospective behavior engine 104 includes an IP address analyzer 112. The IP address analyzer 112 obtains the suspicious sender's IP address and derives its country, sub-division, and ASN and provides this to a second stage detection algorithm within the retrospective behavior engine 104. The IP address analyzer 112 then checks the IP address against existing blocklists from a database 114 and reports the results. The IP address analyzer 112 also checks to see if the sender's IP address of subsequent emails being sent are changing too fast and too soon within a window, e.g., the last 2 to 3 weeks. In configurations, the IP address analyzer 112 performs anomaly detection by building clusters of historical unique IP addresses, country code and ASN and comparing detected emails IP addresses, country and ASN with these clusters. If they do not match, the suspicious email may be considered an anomaly. Standard unsupervised learning clustering algorithms are uses such as, for example, a Gaussian mixture model, to determine the clusters. In configurations, an IP address graph may be created based on the analysis and results of the IP address analyzer 112.

In configurations, the retrospective behavior engine 104 includes a URL analyzer 116. The URL analyzer 116 looks for anomalies in security certificate information and checks for base64 and URL encoded components of a URL in the suspicious email. The URL analyzer 116 checks whether the URL belongs to a legit cloud service or if the URL is using any anti-evasion feature to deliver URLs such as google redirected. In configurations, a URL graph may be created based on the analysis and results of the URL analyzer 116.

In configurations, the retrospective behavior engine 104 includes a recipient/relationship analyzer 118. The recipient/relationship analyzer 118 identifies and reports the unique number of recipients from the suspicious email. Later, the unique number of recipients may be passed on to the second-stage algorithm of the retrospective behavior engine 104. The recipient/relationship analyzer 118 collects all recipients from suspicious emails detected by the adaptive pre-filter 102 and compares them with all the recipients in the past 90 days, for example. Here, metrics may be derived such as, for example, relationship_found, number of recipient matches using the Jaccard index, number of recipient mismatches, number of unique historical recipients, etc. In configurations, a recipient/relationship graph may be created based on the analysis and results of the recipient/relationship analyzer 118.

In configurations, the retrospective behavior engine 104 may include an email statistical analyzer 120 that extracts some additional statistical features from the suspicious email sender such as, for example, a total number of emails sent today, a total number of emails sent in the past, an average number of emails sent in the past, an email ratio, and a number of unique historical IP addresses seen in the past. In configurations, an email profiler may be created based on the analysis and results of the email statistical analyzer 120.

In configurations, the retrospective behavior engine 104 provides the various features to the verdict correlation engine 106 that correlates all of the features. The verdict correlation engine 106 may use human expert knowledge and machine learning to determine the final verdict about a suspicious email and the originating mailbox (suspicious sender's email address from which the suspicious email originated). This final verdict may be one of three classes: benign, suspicious, or malicious.

In configurations, human expert knowledge uses statistical analysis to develop correlation rules on all the features to infer whether the originating mailbox is malicious, suspicious, or benign. Running the system in production with these rules will help catch malicious and benign samples. These samples may later be used by a machine learning model for training.

The features may be used to train a machine learning (ML) model 122 within the verdict correlation engine 106. For this implementation, since a classification problem is being solved, a decision tree implementation may be used. The ML model 122 is trained on thousands of benign and malicious samples and tested on a test set. If the efficacy is high, the ML model 122 is pushed into production to help infuse the final verdict. The expert system and the ML model 122 work in parallel to provide a verdict. Confidence scores may be assigned to the verdict based on agreement or disagreement between these two systems. A high confidence verdict may be the one where both the human expert system and machine learning system have agreed upon the verdict class. A medium confidence verdict may be whenever there is a disagreement.

Once a malicious mailbox is identified, all malicious emails sent by this user (originating email box) are pulled out of all recipient mailboxes within the organization using a retrospective API. A compromised email address is sent to a security platform 124, which can be used send to an active directory 126 and/or CASB 128 to suspend the email address and/or enforce policy to suspend the email address.

In configurations, if the output of the verdict correlation engine 106 is benign, then the email mailbox/address/account from which the suspicious email originated may be labelled as safe. In configurations, if the output of the verdict correlation engine 106 is suspicious, the suspicious email address, along with the feature set extracted from the email, is sent to the security software platform 124. The security software platform 124 pulls email rules created for the user account (the suspicious email box that originated the suspicious email) from an email exchange. For a compromised account, threat actors usually enforce the email rules to forward any invoice or money transfer request to the free email addresses or non-corporate email addresses, delete the emails from the mailbox, forward the email to the trash, etc. The security software platform 124 also pulls out the historic VPN logs of the user. VPN logs contain historic records about the device information from where a user generally logs on, login failure attempts, etc.

In configurations, an alert correlation engine 130 at the security software platform 124 correlates the feature set of suspicious email addresses from the verdict correlation engine 106, correlates with the rules from the email exchange and historical VPN logs to render a verdict on account compromise. Correlation is done by combining the feature set as rules and giving a verdict as a compromised email account or using a supervised learning algorithm to give the verdict as a compromised account.

Once it has been determined that the account has been compromised, e.g., is malicious, the security software sends an actual address to the active directory 126 and the CASB 128. The CASB 128 can enforce policy to block the email address, and the active directory 126 suspends the email account.

In FIG. 1B, in configurations, an example arrangement 100b may use business operating system software (e.g., Microsoft 365) audit logs to determine if there is an account compromise. The audit logs may be analyzed by an audit logs analyzer 132 to compare the suspicious email box (originator) recent activities with historical activities of the suspicious email box. Additionally, VPN logs may be used to determine if there is an account compromise. VPN logs contain historic records about the device information from where a user generally logs on, login failure attempts, etc. The VPN logs may be analyzed by a VPN analyzer 134 to compare the suspicious email box (originator) recent activities with historical activities of the suspicious email box.

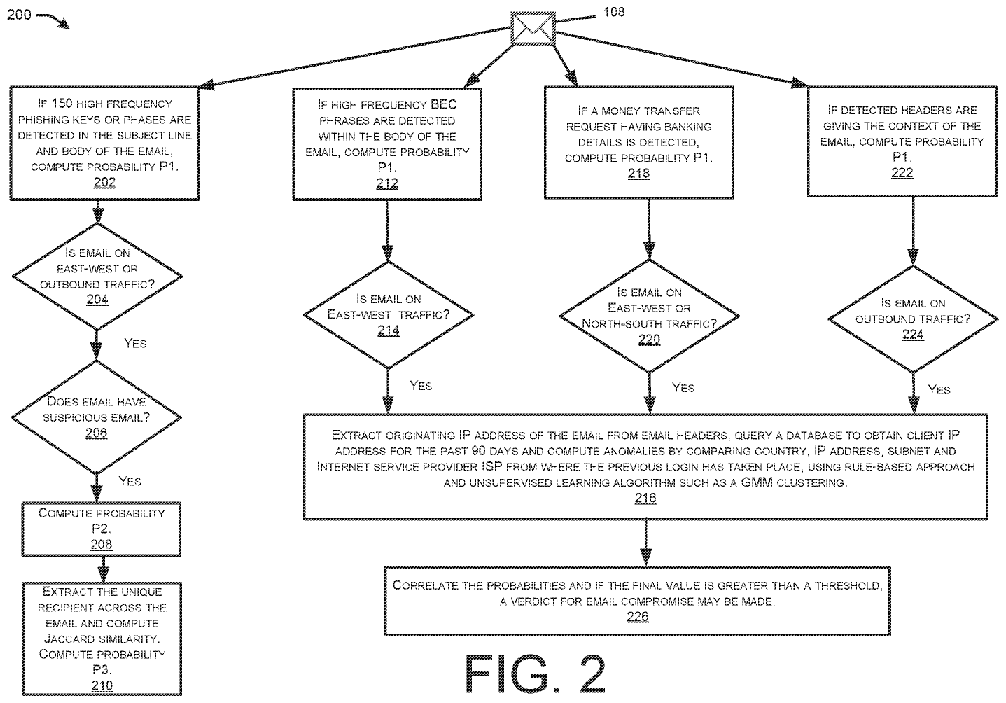

FIG. 2 schematically illustrates an example flow 200 for the example arrangement 100. After receiving an email, e.g., email 108, at 202, if 150 high frequency phishing keys or phrases in the subject line and body of the email, probability P1 is computed. At 204, it may be determined if the email is on East-West or outbound traffic. If no, then stop. If yes, then at 206, it is determined if the email has a suspicious URL. If no, then stop. If it does have a suspicious URL, then at 208 probability P2 is computed. The adaptive pre-filter 102 can then, at 210, extract the unique recipient across the email, e.g., “TO”, “CC” and “BCC,” headers and compute a Jaccard similarity of the email to the closest set of historic set of recipients seen in user sent email from previous month. Probability P3 may then be computed.

At 212, if high frequency BEC phrases are detected within the body of an email and/or subject of an email, probability P1 is computed. At 214, it is determined if the email is on East-West traffic. If no, then stop. If yes, then at 216 extract originating IP address of the email from email headers, query a database, e.g., database 114, to obtain client IP address for the past 90 days and compute anomalies by comparing country, IP address, subnet and Internet service provider ISP from where the previous login has taken place, using rule-based approach and unsupervised learning algorithm such as a GMM clustering. In configurations, K-mean clustering may be used. Probability P4 is then computed.

At 218, if a money transfer request having banking details is detected, probability P1 is computed. At 220, it may be determined if the email is on East-West or North-South traffic. From 220, the flow 200 continues to 216.

At 222, if detected headers of the email are giving the context of the email, probability P1 is computed. At 224, it may be determined if the email is on outbound traffic. From 224, the flow 200 continues to 216.

At 226, the flow 200 can then correlate the probabilities and if the final value is greater than a threshold, a verdict for email account compromise may be made. For example, if the probabilities are correlated and are above a predetermined threshold, then the email account from which the email originated may be classified as suspicious. If the probabilities are correlated and are above a higher predetermined threshold, then the email account from which the email originated may be classified as malicious. Otherwise, the email account from which the email originated may be classified as benign.

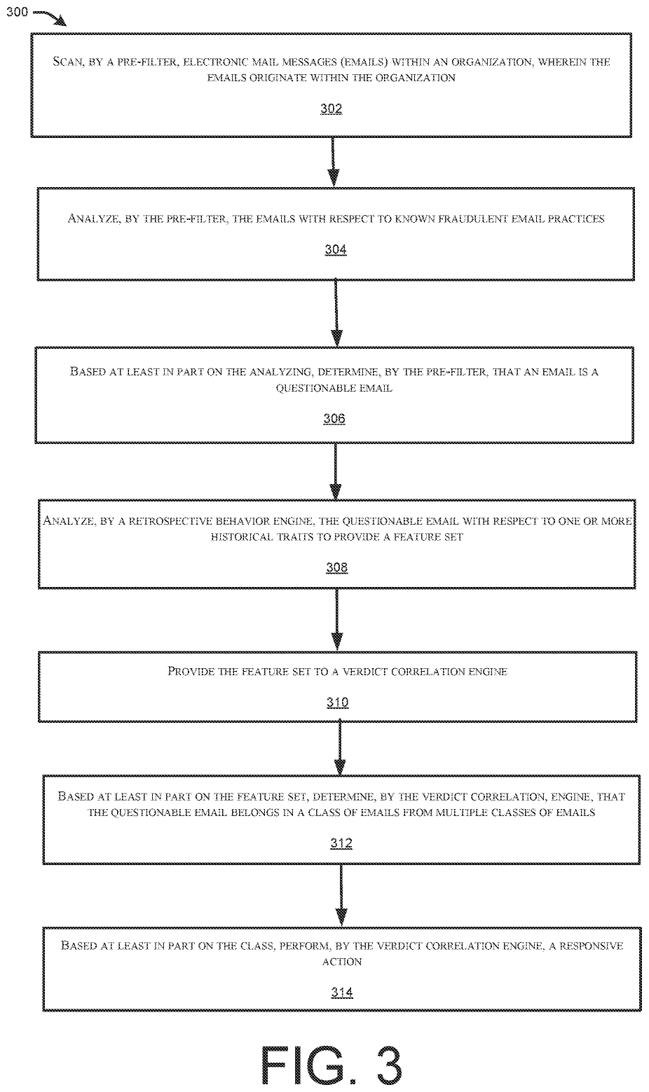

FIG. 3 illustrates a flow diagram of an example method 300 and illustrates aspects of the functions performed at least partly by devices of a network as described with respect to FIGS. 1A, 1B, and 2. The logical operations described herein with respect to FIG. 3 may be implemented (1) as a sequence of computer-implemented acts or program modules running on a computing system, and/or (2) as interconnected machine logic circuits or circuit modules within the computing system.

The implementation of the various components described herein is a matter of choice dependent on the performance and other requirements of the computing system. Accordingly, the logical operations described herein are referred to variously as operations, structural devices, acts, or modules. These operations, structural devices, acts, and modules can be implemented in software, in firmware, in special purpose digital logic, and any combination thereof. It should also be appreciated that more or fewer operations might be performed than shown in FIG. 3 and described herein. These operations can also be performed in parallel, or in a different order than those described herein. Some or all of these operations can also be performed by components other than those specifically identified. Although the techniques described in this disclosure are with reference to specific components, in other examples, the techniques may be implemented by less components, more components, different components, or any configuration of components.

FIG. 3 illustrates a flow diagram of an example method 300 for detecting a compromised mailbox as an email account compromise (EAC) involved in lateral phishing, lateral scam, lateral BEC, outbound scam, lateral and inbound fraudulent money transfer requests. In some examples, the method 300 may be performed by a system comprising one or more processors and one or more non-transitory computer-readable media storing computer-executable instructions that, when executed by the one or more processors, cause the one or more processors to perform the method 300.

At 302, a pre-filter scans electronic mail messages (emails) within an organization, wherein the emails originate within the organization. At 304, the pre-filter analyzes the emails with respect to known fraudulent email practices. At 306, based at least in part on the analyzing, the pre-filter determines that an email is a questionable email.

For example, in configurations, the pre-filter 102 scans internal and outbound emails 108 sent by any user within an organization. These emails 108 are matched against known phishing and scam traits to identify suspicious or questionable emails and are shortlisted for additional analysis. The adaptive pre-filter 102 is a system that looks at phishing and scam exemplar emails as input and automatically generates and suggests rules based on high-frequency keywords and key phrases. These high-frequency keywords and keyphrases are extracted using NLP techniques such as N-grams and leverage embeddings from BERT-like models. These keywords and keyphrases are then used to create and suggest rules to a rule engine 110.

In configurations, rules suggested by the adaptive pre-filter 102 to the rule engine 110 are then converted into email detection rules. These rules may be implemented as Yara rules or Rspamd rules and published and deployed in production to scan internal (east-west) and outbound emails. Any matching email is then shortlisted for further analysis by the retrospective behavior engine. Any message matching the adaptive pre-filter criteria is then sent to retrospective behavior engine for additional checks. The rule engine 110 performs a 90-day (for example) retrospective lookup of user email sending meta-data and identifies anomalous behavior patterns in it by comparing it with the current-day email-sending patterns.

At 308, a retrospective behavior engine analyzes the questionable email with respect to one or more historical traits to provide a feature set. For all suspicious or questionable (referred to herein as suspicious) emails found, the retrospective behavior engine 104 analyzes uniform resource locators (URLs) in the suspicious emails for anomalies in security certificates such as, for example, secure socket layer (SSL) certificates, etc., whether the URL belongs to a cloud service or contains URL or base64 encoded components of a URL such as an email within the suspicious email. Internet protocol (IP) addresses of these suspicious emails are analyzed, noted, and later used to compare with historical IP addresses. The retrospective behavior engine 104 checks whether IP address belongs to any known block list or suspicious country. Recipients of the suspicious emails are analyzed and compared with historical recipients. The number of recipients is noted.

In configurations, a 90-day (for example) retrospective lookup of the suspicious sender's (originator of the suspicious email) email-sending behavior is performed by the retrospective behavior engine 104. The IP address, country, and sub-division of the suspicious sender's IP address are derived and compared with all the suspicious historical IP addresses. A similarity score may be assigned, yielding the most similar match. Clusters are formed on historical IP addresses, their country, and autonomous system number (ASN), and an anomaly detection algorithm is used to compare the detected IP address against these clusters. If there is no match, it is considered an anomaly. The suspicious sender's historical IP addresses are analyzed by the retrospective behavior engine 104, looking for patterns that suggest that the suspicious sender's IP address is changing too fast and from far away distances.

The suspicious sender's historical recipients are analyzed by the retrospective behavior engine 104 and compared with current recipients to derive matching and non-matching relationships. Some additional statistical features are extracted such as, for example, total number of emails sent today, total number of emails sent in the past, average number of emails sent in the past, email ratio, unique historical IP addresses seen in the past, etc.

At 310, the feature set is provided to a verdict correlation engine. For example, in configurations, the retrospective behavior engine 104 provides the various features to the verdict correlation engine 106 that correlates all of the features. The verdict correlation engine 106 may use human expert knowledge and machine learning to determine the final verdict about a suspicious email and the originating mailbox (suspicious sender's email address from which the suspicious email originated). This final verdict may be one of three classes: benign, suspicious, or malicious.

In configurations, human expert knowledge uses statistical analysis to develop correlation rules on all the features to infer whether the originating mailbox is malicious, suspicious, or benign. Running the system in production with these rules will help catch malicious and benign samples. These samples may later be used by a machine learning model for training.

The features may be used to train a machine learning (ML) model 122 within the verdict correlation engine 106. For this implementation, since a classification problem is being solved, a decision tree implementation may be used. The ML model 122 is trained on thousands of benign and malicious samples and tested on a test set. If the efficacy is high, the ML model 122 is pushed into production to help infer the final verdict. The expert system and the ML model 122 work in parallel to provide a verdict. Confidence scores may be assigned to the verdict based on agreement or disagreement between these two systems. A high confidence verdict may be the one where both the human expert system and machine learning system have agreed upon the verdict class. A medium confidence verdict may be whenever there is a disagreement.

In configurations, an alert correlation engine 130 at the security software platform correlates the feature set of suspicious email addresses from the verdict correlation engine 106, correlates with the rules from the email exchange and historical VPN logs to render a verdict on account compromise. Correlation is done by combining the feature set as rules and giving a verdict as a compromised email account or using a supervised learning algorithm to give the verdict as a compromised account.

At 312, based at least in part on the feature set, the verdict correlation engine determines that the questionable email belongs in a class of emails from multiple classes of emails. For example, in configurations, the retrospective behavior engine 104 provides the various features to the verdict correlation engine 106 that correlates all of the features. The verdict correlation engine 106 may use human expert knowledge and machine learning to determine the final verdict about a suspicious email and the originating mailbox (suspicious sender's email address from which the suspicious email originated). This final verdict may be one of three classes: benign, suspicious, or malicious.

At 314, based at least in part on the class, the verdict correlation engine performs a responsive action. For example, once a malicious mailbox is identified, all malicious emails sent by this user (originating email box) are pulled out of all recipient mailboxes within the organization using a retrospective API. A compromised email address is sent to a security platform 124, which can be used send to an active directory 126 and/or CASB 128 to suspend the email address and/or enforce policy to suspend the email address.

Once a malicious mailbox is identified, all malicious emails sent by this user (originating email box) are pulled out of all recipient mailboxes within the organization using a retrospective API. A compromised email address is sent to a security platform 124, which can be used send to an active directory 126 and/or CASB 128 to suspend the email address and/or enforce policy to suspend the email address.

In configurations, if the output of the verdict correlation engine 106 is benign, then the email mailbox/address/account from which the suspicious email originated may be labelled as safe. In configurations, if the output of the verdict correlation engine 106 is suspicious, the suspicious email address, along with the feature set extracted from the email, is sent to the security software platform 124. The security software platform 124 pulls email rules created for the user account (the suspicious email box that originated the suspicious email) from an email exchange. For a compromised account, threat actors usually enforce the email rules to forward any invoice or money transfer request to the free email addresses or non-corporate email addresses, delete the emails from the mailbox, forward the email to the trash, etc. The security software platform also pulls out the historic VPN logs of the user. VPN logs contain historic records about the device information from where a user generally logs on, login failure attempts, etc.

Thus, the techniques and architecture described herein help an organization detect compromised email mailboxes as email account compromise (EAC), lateral phishing, and lateral scam by analyzing the current email-sending behavior of the sender and comparing it with the sender's retrospective email-sending behavior along with some additional peripheral features from the email. This capability may integrated into a secure email gateway (SEG) and helps users detect internal threats that otherwise would not have been detected due to the nature of the compromise.

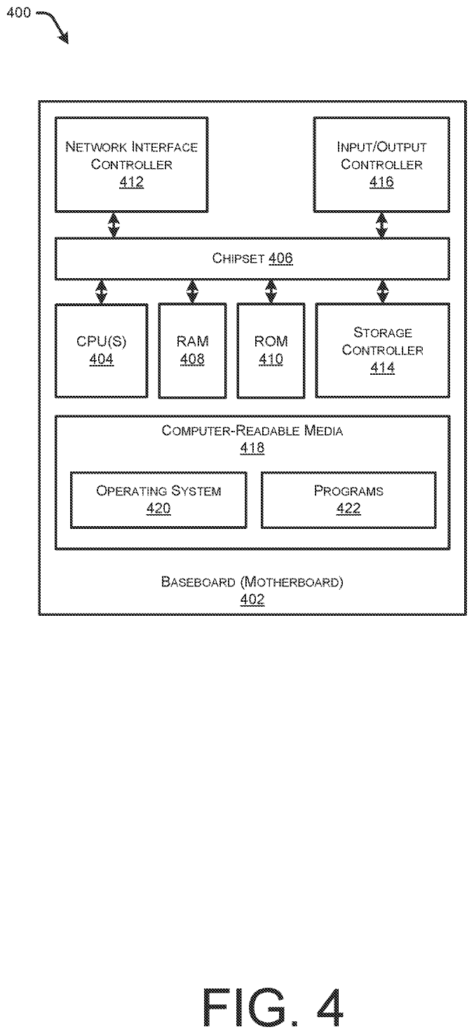

FIG. 4 shows an example computer architecture for a computing device 400 capable of executing program components for implementing the functionality described above. In configurations, one or more of the computing devices 400 may be used to implement one or more of the components of FIGS. 1A, 1B, 2, and 3. The computer architecture shown in FIG. 4 illustrates a conventional server computer, router, switch, workstation, desktop computer, laptop, tablet, network appliance, e-reader, smartphone, or other computing device, and can be utilized to execute any of the software components presented herein. The computing device 400 may, in some examples, correspond to a physical device or resources described herein.

The computing device 400 includes a baseboard 402, or “motherboard,” which is a printed circuit board to which a multitude of components or devices can be connected by way of a system bus or other electrical communication paths. In one illustrative configuration, one or more central processing units (“CPUs”) 404 operate in conjunction with a chipset 406. The CPUs 404 can be standard programmable processors that perform arithmetic and logical operations necessary for the operation of the computing device 400.

The CPUs 404 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 406 provides an interface between the CPUs 404 and the remainder of the components and devices on the baseboard 402. The chipset 406 can provide an interface to a RAM 408, used as the main memory in the computing device 400. The chipset 406 can further provide an interface to a computer-readable storage medium such as a read-only memory (“ROM”) 410 or non-volatile RAM (“NVRAM”) for storing basic routines that help to startup the computing device 400 and to transfer information between the various components and devices. The ROM 410 or NVRAM can also store other software components necessary for the operation of the computing device 400 in accordance with the configurations described herein.

The computing device 400 can operate in a networked environment using logical connections to remote computing devices and computer systems through a network, such as the example arrangement 100. The chipset 406 can include functionality for providing network connectivity through a NIC 412, such as a gigabit Ethernet adapter. In configurations, the NIC 412 can be a smart NIC (based on data processing units (DPUs)) that can be plugged into data center servers to provide networking capability. The NIC 412 is capable of connecting the computing device 400 to other computing devices over networks. It should be appreciated that multiple NICs 412 can be present in the computing device 400, connecting the computer to other types of networks and remote computer systems.

The computing device 400 can include a storage device 418 that provides non-volatile storage for the computer. The storage device 418 can store an operating system 420, programs 422, and data, which have been described in greater detail herein. The storage device 418 can be connected to the computing device 400 through a storage controller 414 connected to the chipset 406. The storage device 418 can consist of one or more physical storage units. The storage controller 414 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computing device 400 can store data on the storage device 418 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 418 is characterized as primary or secondary storage, and the like.

For example, the computing device 400 can store information to the storage device 418 by issuing instructions through the storage controller 414 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 400 can further read information from the storage device 418 by detecting the physical states or characteristics of one or more particular locations within the physical storage units.

In addition to the mass storage device 418 described above, the computing device 400 can have access to other computer-readable storage media to store and retrieve information, such as program modules, data structures, or other data. It should be appreciated by those skilled in the art that computer-readable storage media is any available media that provides for the non-transitory storage of data and that can be accessed by the computing device 400. In some examples, the operations performed by the cloud network, and or any components included therein, may be supported by one or more devices similar to computing device 400. Stated otherwise, some or all of the operations described herein may be performed by one or more computing devices 400 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 418 can store an operating system 420 utilized to control the operation of the computing device 400. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 418 can store other system or application programs and data utilized by the computing device 400.

In one embodiment, the storage device 418 or other computer-readable storage media is encoded with computer-executable instructions which, when loaded into the computing device 400, transform the computer from a general-purpose computing system into a special-purpose computer capable of implementing the embodiments described herein. These computer-executable instructions transform the computing device 400 by specifying how the CPUs 404 transition between states, as described above. According to one embodiment, the computing device 400 has access to computer-readable storage media storing computer-executable instructions which, when executed by the computing device 400, perform the various processes described above with regard to FIGS. 1A, 1B, 2, and 3. The computing device 400 can also include computer-readable storage media having instructions stored thereupon for performing any of the other computer-implemented operations described herein.

The computing device 400 can also include one or more input/output controllers 416 for receiving and processing input from a number of input devices, such as a keyboard, a mouse, a touchpad, a touch screen, an electronic stylus, or other type of input device. Similarly, an input/output controller 416 can provide output to a display, such as a computer monitor, a flat-panel display, a digital projector, a printer, or other type of output device. It will be appreciated that the computing device 400 might not include all of the components shown in FIG. 4, can include other components that are not explicitly shown in FIG. 4, or might utilize an architecture completely different than that shown in FIG. 4.

The computing device 400 may support a virtualization layer, such as one or more virtual resources executing on the computing device 400. In some examples, the virtualization layer may be supported by a hypervisor that provides one or more virtual machines running on the computing device 400 to perform functions described herein. The virtualization layer may generally support a virtual resource that performs at least portions of the techniques described herein.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method comprising:
scanning, by a pre-filter, electronic mail messages (emails) within an organization, wherein the emails originate within the organization;
analyzing, by the pre-filter, the emails with respect to known fraudulent email practices;
determining, by the pre-filter, that an email is a questionable email;
analyzing, by a retrospective behavior engine, the questionable email with respect to one or more historical traits to provide a feature set;
providing the feature set to a verdict correlation engine;
based at least in part on the feature set, determining, by the verdict correlation engine, that the questionable email belongs in a class of emails from multiple classes of emails; and
based at least in part on the class, performing, by the verdict correlation engine a responsive action.

2. The method of claim 1, wherein the multiple classes comprise (i) benign, (ii) suspicious, or (iii) malicious.

3. The method of claim 2, wherein if the questionable email is benign, the responsive action comprises deeming an originating email address of the questionable email as safe.

4. The method of claim 2, wherein if the questionable email is deemed suspicious, the responsive action comprises forwarding an originating email address of the questionable email to a security platform for monitoring and rule enforcement.

5. The method of claim 2, wherein if the questionable email is deemed malicious, the responsive action comprises forwarding an originating email address of the questionable email to a security platform that forwards the originating email address to (i) an account directory that suspends an account of the originating email address and (ii) a cloud access security broker (CASB) that blocks the originating email address.

6. The method of claim 5, wherein the responsive action further comprises removing the questionable email from any email accounts that received the questionable email.

7. The method of claim 1, wherein analyzing, by the retrospective behavior engine, the questionable email with respect to the one or more historical traits to provide the feature set comprises one or more of:
analyzing uniform resource locators (URLs) in the questionable email for one or more of (i) for anomalies in security certificates, (ii) whether a URL belongs to a cloud service, or (iii) whether the URL contains URL or base64 encoded components of a URL;
analyzing Internet Protocol (IP) addresses in the questionable email and one or more of (i) comparing the IP addresses with historical IP addresses, (ii) checking whether an IP address is included on a list of blocked IP addresses, or (iii) checking whether the IP address is located in a suspicious country;
comparing one or more recipients with historical recipients; or
analyzing a historical email-sending behavior of a sender of the questionable email.

8. The method of claim 1, wherein analyzing, by the retrospective behavior engine, the questionable email with respect to the one or more historical traits to provide the feature set comprises one or more of:
analyzing operating system audit log events; or
analyzing virtual private network (VPN) logs.

9. A system comprising:
one or more processors; and
one or more non-transitory computer-readable media storing computer-executable instructions that, when executed by the one or more processors, cause the one or more processors to perform actions comprising:
scanning, by a pre-filter, electronic mail messages (emails) within an organization, wherein the emails originate within the organization;
analyzing, by the pre-filter, the emails with respect to known fraudulent email practices;
determining, by the pre-filter, that an email is a questionable email;
analyzing, by a retrospective behavior engine, the questionable email with respect to one or more historical traits to provide a feature set;
providing the feature set to a verdict correlation engine;
based at least in part on the feature set, determining, by the verdict correlation engine, that the questionable email belongs in a class of emails from multiple classes of emails; and
based at least in part on the class, performing, by the verdict correlation engine a responsive action.

10. The system of claim 9, wherein the multiple classes comprise (i) benign, (ii) suspicious, or (iii) malicious.

11. The system of claim 10, wherein if the questionable email is benign, the responsive action comprises deeming an originating email address of the questionable email as safe.

12. The system of claim 10, wherein if the questionable email is deemed suspicious, the responsive action comprises forwarding an originating email address of the questionable email to a security platform for monitoring and rule enforcement.

13. The system of claim 10, wherein if the questionable email is deemed malicious, the responsive action comprises forwarding an originating email address of the questionable email to a security platform that forwards the originating email address to (i) an account directory that suspends an account of the originating email address and (ii) a cloud access security broker (CASB) that blocks the originating email address.

14. The system of claim 13, wherein the responsive action further comprises removing the questionable email from any email accounts that received the questionable email.

15. The system of claim 9, wherein analyzing, by the retrospective behavior engine, the questionable email with respect to the one or more historical traits to provide the feature set comprises one or more of:
analyzing uniform resource locators (URLs) in the questionable email for one or more of (i) for anomalies in security certificates, (ii) whether a URL belongs to a cloud service, or (iii) whether the URL contains URL or base64 encoded components of a URL;
analyzing Internet Protocol (IP) addresses in the questionable email and one or more of (i) comparing the IP addresses with historical IP addresses, (ii) checking whether an IP address is included on a list of blocked IP addresses, or (iii) checking whether the IP address is located in a suspicious country;
comparing one or more recipients with historical recipients; or
analyzing a historical email-sending behavior of a sender of the questionable email.

16. The system of claim 9, wherein analyzing, by the retrospective behavior engine, the questionable email with respect to the one or more historical traits to provide the feature set comprises one or more of:
analyzing operating system audit log events; or
analyzing virtual private network (VPN) logs.

17. One or more non-transitory computer-readable media storing computer-executable instructions that, when executed by one or more processors, cause the one or more processors to perform actions comprising:
scanning, by a pre-filter, electronic mail messages (emails) within an organization, wherein the emails originate within the organization;
analyzing, by the pre-filter, the emails with respect to known fraudulent email practices;
determining, by the pre-filter, that an email is a questionable email;
analyzing, by a retrospective behavior engine, the questionable email with respect to one or more historical traits to provide a feature set;
providing the feature set to a verdict correlation engine;
based at least in part on the feature set, determining, by the verdict correlation engine, that the questionable email belongs in a class of emails from multiple classes of emails; and
based at least in part on the class, performing, by the verdict correlation engine a responsive action.

18. The one or more non-transitory computer-readable media of claim 17, wherein analyzing, by the retrospective behavior engine, the questionable email with respect to the one or more historical traits to provide the feature set comprises one or more of:
analyzing uniform resource locators (URLs) in the questionable email for one or more of (i) for anomalies in security certificates, (ii) whether a URL belongs to a cloud service, or (iii) whether the URL contains URL or base64 encoded components of a URL;
analyzing Internet Protocol (IP) addresses in the questionable email and one or more of (i) comparing the IP addresses with historical IP addresses, (ii) checking whether an IP address is included on a list of blocked IP addresses, or (iii) checking whether the IP address is located in a suspicious country;
comparing one or more recipients with historical recipients; or
analyzing a historical email-sending behavior of a sender of the questionable email.

19. The one or more non-transitory computer-readable media of claim 17, wherein analyzing, by the retrospective behavior engine, the questionable email with respect to the one or more historical traits to provide the feature set comprises one or more of:
analyzing operating system audit log events; or
analyzing virtual private network (VPN) logs.

20. The one or more non-transitory computer-readable media of claim 17, wherein:
the multiple classes comprise (i) benign, (ii) suspicious, or (iii) malicious;
if the questionable email is benign, the responsive action comprises deeming an originating email address of the questionable email as safe;
if the questionable email is deemed suspicious, the responsive action comprises forwarding the originating email address to a security platform for monitoring and rule enforcement; and
if the questionable email is deemed malicious, the responsive action comprises removing the questionable email from any email accounts that received the questionable email and forwarding the originating email address to a security platform that forwards the originating email address to (i) an account directory that suspends an account of the originating email address and (ii) a cloud access security broker (CASB) that blocks the originating email address.
